(19) United States
(12) Patent Application Publication
(10) Pub. No.: US 2004/0210748 A1
(43) Pub. Date: Oct. 21, 2004

(54) Processor and method capable of executing conditional instructions

(75) Inventor: Bor-Sung Liang, Kaohsiung City (TW)

Correspondence Address: BACON & THOMAS, PLLC, 625 SLATERS LANE, FOURTH FLOOR, ALEXANDRIA, VA, 22314

(73) Assignee: Sunplus Technology Co., Ltd., Hsinchu (TW)

(21) Appl. No.: 10/695,812

(22) Filed: Oct. 30, 2003

(30) Foreign Application Priority Data
Apr. 15, 2003 (TW) 92108638

(51) Int. Cl. G06F 9/44

(52) U.S. Cl. 712/229

(57) ABSTRACT

A processor and method capable of executing conditional instructions is disclosed, which can execute an instruction set including M-bit instructions and N-bit instructions. The instruction set has condition execution instructions and M-bit parallel condition execution instructions. Each parallel condition execution instruction has a first and a second N-bit instruction. An instruction fetching device fetches at least one instruction to be performed. An instruction decoder decodes the instruction fetched by the instruction fetching device. An instruction executing device executes the instruction outputted by the instruction decoder, wherein a flag is set according to a result of executing a condition execution instruction. A mode switching device switches the instruction decoder to decode one of the first and the second N-bit instructions according to the state of the flag, so as to be subsequently performed by the instruction executing device, when a parallel condition execution instruction is fetched.

### BACKGROUND OF THE INVENTION

1. Field of the Invention

The present invention relates to the technical field of processors and, more particularly, to a processor capable of executing conditional instructions.

2. Description of Related Art

Typically, a processor on executing a conditional instruction will produce a state of condition acceptance or rejection, and accordingly uses a branch or jump instruction to perform the subsequent program or procedure. As such, instructions in a pipeline are refreshed due to the branch or jump instruction, so as to read a destination instruction indicated by the branch or jump instruction. Such a process is ineffective to a processor with a pipeline processing.

To eliminate the above problem, U.S. Pat. No. 5,961,633 granted to Jaggar for an “Execution of data processing instructions” uses a 4-bit (from 31-st to 28-th bits) condition field and 28-bit (from 27-th to 0-th bits) operation field on instruction decode. Also, a condition tester is applied to test the condition field and four flags N, Z, C, V of the processor, to produce an output signal to determine whether to discard the instruction or not. The operating process is illustrated in FIG. 1, which shows C programming codes. FIG. 2 is a schematic view of instructions in machine codes after the C programming codes of FIG. 1 are compiled and assembled. When the processor executes the instruction (1), the Z flag of the processor is set, as the content of register R1 is 0. When the processor executes the instruction (2), the condition field of instruction (2) is EQ. The condition tester tests the condition field and thus obtains a state that is the same as the Z flag. Therefore, no output signal is produced and the instruction (2) is normally executed by the processor. When the processor executes the instruction (6), the condition field of instruction (6) is NE. The condition tester tests the condition field and thus obtains a state that is different from the Z flag, so that the output signal is produced, and although the instruction (6) is executed by the processor, the result is discarded.

When the processor executes the C programming codes shown in FIG. 1, the instructions (1) to (10) are performed. When the content of R1 is 0, the results performed on instructions (6) to (9) are discarded, and otherwise, the results performed on instructions (2) to (5) are discarded.

When a processor employs such a method to execute conditional instructions, the subsequent program or procedure can be performed without using the branch or jump instruction and the result as aforementioned. This can prevent instructions in a pipeline from being refreshed, thus increasing efficiency of the processor with a pipeline processing.

However, such a processor requires 4-bit condition field in an instruction. For a 16-bit instruction, only 12 bits are remained in use for encoding. This does not meet with the typical instruction number requirement. Therefore, such a design of condition field is not existed in a 16-bit instruction. Moreover, in this conventional skill, no matter what the result of the conditional instruction, the subsequent instructions have to be performed but some of the results are discarded. This also adds the load of the processor. Therefore, the design of conditional instruction processing for processor in the prior art is not satisfactory.

### SUMMARY OF THE INVENTION

The object of the present invention is to provide a processor and method capable of executing conditional instructions, which increase the efficiency of a processor with a pipeline processing in using branch or jump instruction, and which also prevents using a long encoding field and avoids occupying the pipeline processing time when no instruction is performed, so as to increase the code density and performance.

According to a feature of the present invention, there is provided a processor capable of executing conditional instructions. The instruction set executed by the processor includes M-bit instructions and N-bit instructions (where M, N are positive integers, M>N). The instruction set has condition execution instructions and M-bit parallel condition execution instructions. The parallel condition execution instruction has a first N-bit instruction and a second N-bit instruction. The processor comprises: a flag having a state; an instruction fetching device, to fetch at least one instruction to be performed; an instruction decoder, to decode the instruction fetched by the instruction fetching device; an instruction executing device, to execute the instruction outputted by the instruction decoder, wherein the state of the flag is set according to a result of executing a condition execution instruction, which indicates a state of condition acceptance or rejection; and a mode switching device, to switch the instruction decoder to decode one of the first and the second N-bit instructions according to the state of the flag, so as to be subsequently performed by the instruction executing device, when a parallel condition execution instruction is fetched by the instruction fetching device.

According to another feature of the present invention, there is provided a method capable of executing conditional instructions in a processor. The instruction set executed by the processor includes M-bit instructions and N-bit instructions (where M, N are positive integers, M>N). The instruction set having condition execution instructions and M-bit parallel condition execution instructions. The parallel condition execution instruction has a first and a second N-bit instructions. The method comprises: (A) fetching at least one instruction to be decoded and executed; (B) when a condition execution instruction is performed, setting a flag to a first logic state if the execution results in a condition acceptance, and setting the flag to a second logic state if the execution results in a condition rejection; and (C) when the instruction fetched is a parallel condition execution instruction, decoding and executing the first N-bit instruction if the flag is on the first logic state, and decoding and executing the second N-bit instruction if the flag is on the second logic state.

Other objects, advantages, and novel features of the invention will become more apparent from the following detailed description when taken in conjunction with the accompanying drawings.

### BRIEF DESCRIPTION OF THE DRAWINGS

FIG. 1 is a view of C programming codes;

FIG. 2 is a schematic view of instructions in machine codes after the C programming codes of FIG. 1 are compiled and assembled;

FIG. 3 is a block diagram of a processor capable of executing conditional instructions in accordance with the invention;

FIG. 4 is a view of the format of a parallel condition execution instruction in accordance with the invention;

FIG. 5 is a schematic view of instructions in machine codes after the C programming codes of FIG. 1 are compiled and assembled in accordance with the invention;

FIG. 6 is a schematic view of another embodiment of the invention;

FIG. 7 is a schematic view of still another embodiment of the invention; and

FIG. 8 is a schematic view of further another embodiment of the invention.

### DETAILED DESCRIPTION OF THE PREFERRED EMBODIMENT

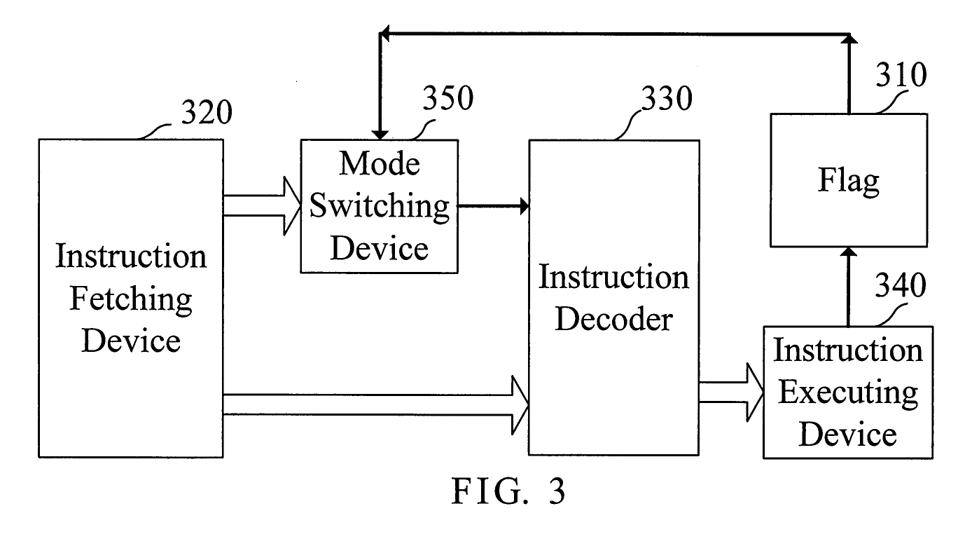

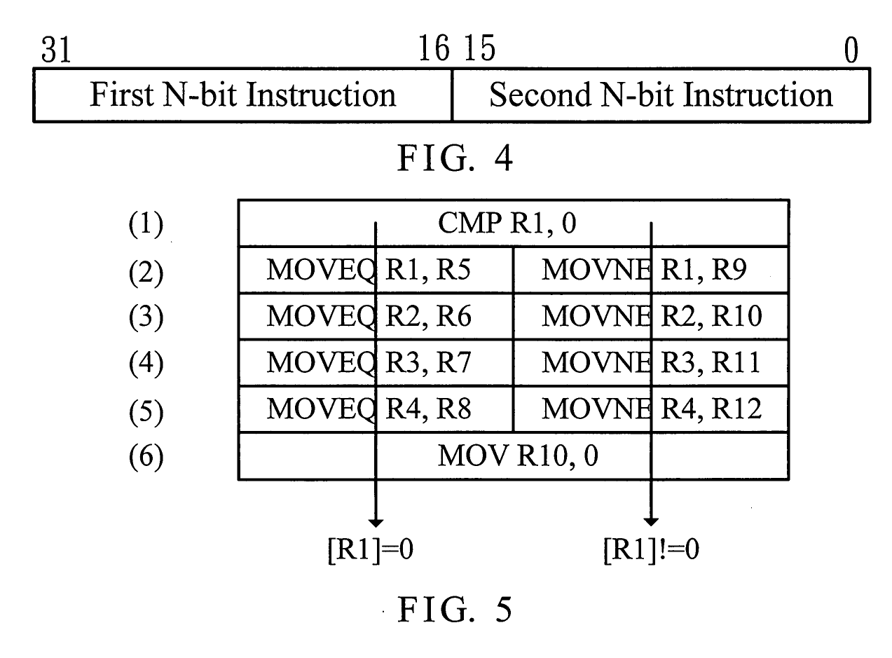

FIG. 3 is a block diagram of a processor capable of executing conditional instructions in accordance with the invention. The processor includes a flag 310, an instruction fetching device 320, an instruction decoder 330, an instruction executing device 340 and a mode switching device 350. The instruction fetching device 320 is provided to fetch at least one instruction to be performed. The instruction set performed by the processor includes M-bit instructions and N-bit instructions (where M, N are positive integers, M>N, e.g., M=32 and N=16). In addition to the general M-bit and N-bit instructions, the instruction set also has N-bit or M-bit condition execution instructions (for example, compare instruction) and M-bit parallel condition execution instructions. Each parallel condition execution instruction is an M-bit instruction with at least two N-bit instructions. As shown in FIG. 4, a 32-bit parallel condition execution instruction has a first N-bit (N=16) instruction and a second N-bit instruction, wherein the result of executing the condition execution instruction determines which of the first or second N-bit instruction to be executed.

The instruction decoder 330 decodes the instruction fetched by the instruction fetching device 320. The instruction executing device 340 executes the instruction outputted by the instruction decoder 330. When the executed instruction is an N-bit or M-bit condition execution instruction, the instruction executing device 340 sets the flag 310 according to the result of executing the condition execution instruction. Namely, the flag 310 is set to “true” when the result performed on the condition execution instruction is condition acceptance, and conversely to “false”.

The mode switching device 350 is provided to switch the mode of the processor on executing a parallel condition execution instruction. When the instruction fetched by the instruction fetching device 320 is a parallel condition execution instruction, the mode switching device 350 switches the instruction decoder 330 based on the flag 310 to decode between the first and second N-bit instructions. Namely, the instruction decoder 330 decodes the first N-bit instruction when the flag 310 is on “true” state and the instruction executing device 340 thus executes the first N-bit instruction. Alternatively, the instruction decoder 330 decodes the second N-bit instruction when the flag 310 is on “false” state and the instruction executing device 340 thus executes the second N-bit instruction.

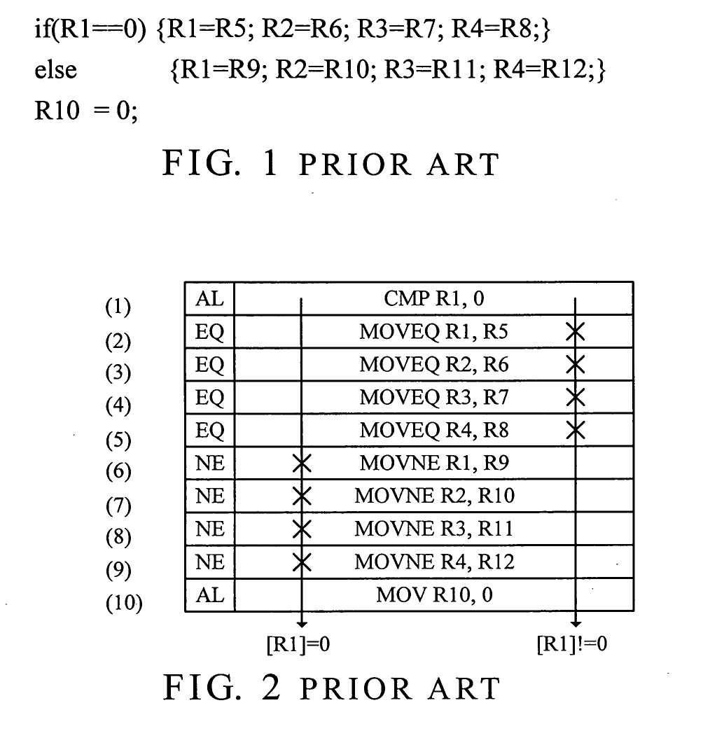

FIG. 5 shows an embodied example. In FIG. 5, C programming codes of FIG. 1 are compiled and assembled into a schematic view of instructions in the form of machine codes. As shown in FIG. 5, the instruction (1) is an M-bit (M=32) condition execution instruction (compare instruction). When the processor executes the instruction (1) and the content of register R1 is 0, the comparison obtains the same result, so that the result performed on the condition execution instruction is condition acceptance. Therefore, the flag 310 is set to “true”. At this point, when the processor executes the parallel condition execution instruction (2), the processor finds the flag as true and thus executes only the first N-bit instruction [MOVEQ R1, R5] without executing the second N-bit instruction [MOVNE R1, R9]. Similarly, for subsequent parallel condition execution instructions (3)˜(5), the processor executes only corresponding first N-bit instructions, i.e., instructions [MOVEQ R2, R6], [MOVEQ R3, R7], and [MOVEQ R4, R8], since the flag 310 is set to “true”. Next, the processor continuously executes the general M-bit instruction (6) as there is no more parallel condition execution instruction.

When the processor executes the instruction (1) and the content of register R1 is not 0, the comparison obtains different results, so that the result performed on the condition execution instruction is condition rejection. Therefore, the flag 310 is set to “false”. At this point, when the processor executes the parallel condition execution instruction (2)˜(5), the processor finds the flag as “false” and thus executes only corresponding second N-bit instructions, i.e., [MOVNE R1, R9], [MOVNE R2, R10], [MOVNE R3, R11], and [MOVNE R4, R12]. Next, the processor continuously executes the general M-bit instruction (6) as there is no more parallel condition execution instruction.

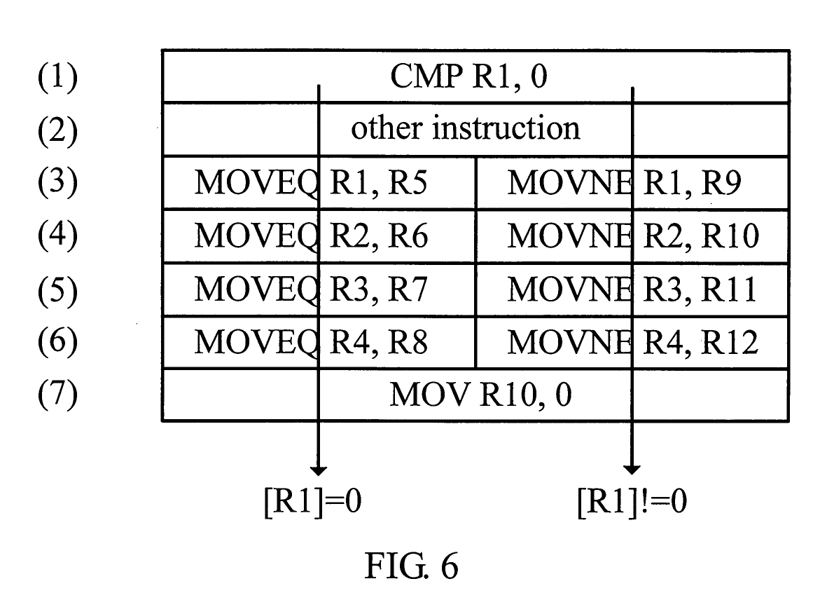

FIG. 6 is a schematic view of another embodiment in accordance with the invention. In FIG. 6, additional instructions can be presented between condition execution instruction (instruction (1)) and parallel condition execution instruction (instruction (3)) without affecting the flag. When the processor executes instruction (1), the flag 310 is set based on the result performed on the instruction (1). Because the instruction (2) does not affect the flag, the processor is still based on the flag 310 to select first N-bit instructions or second N-bit instructions of the parallel condition execution instructions (3) to (6) to execute.

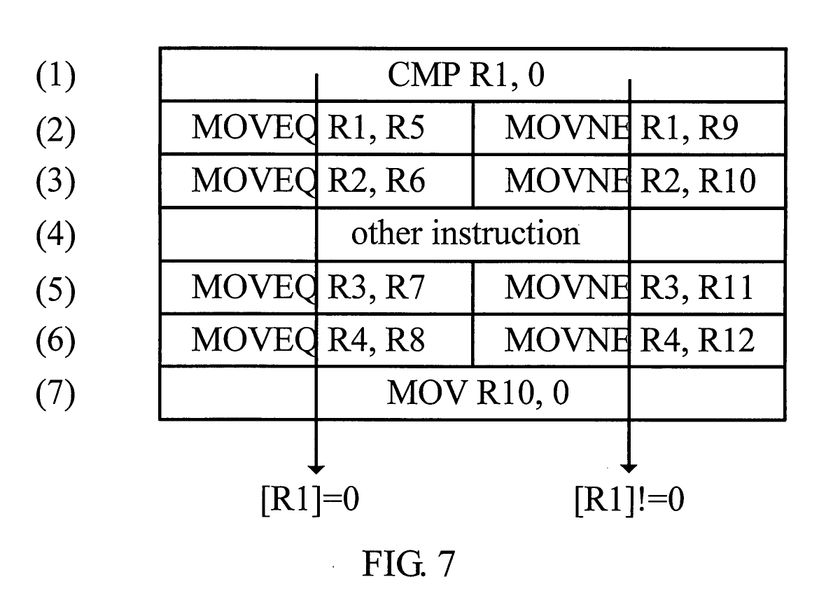

FIG. 7 is a schematic view of another embodiment in accordance with the invention. In FIG. 7, additional instructions can be presented between parallel condition execution instructions without affecting the flag. As shown in FIG. 7, when the processor executes the instruction (1), the flag 310 is set based on the result performed on the instruction (1). Because the instruction (4) does not affect the flag, the processor is still based on the flag 310 to select first N-bit instruction (MOVEQ R3, R7) or second N-bit instruction (MOVNE R3, R11) of the parallel condition execution instructions (5) to (6) to execute.

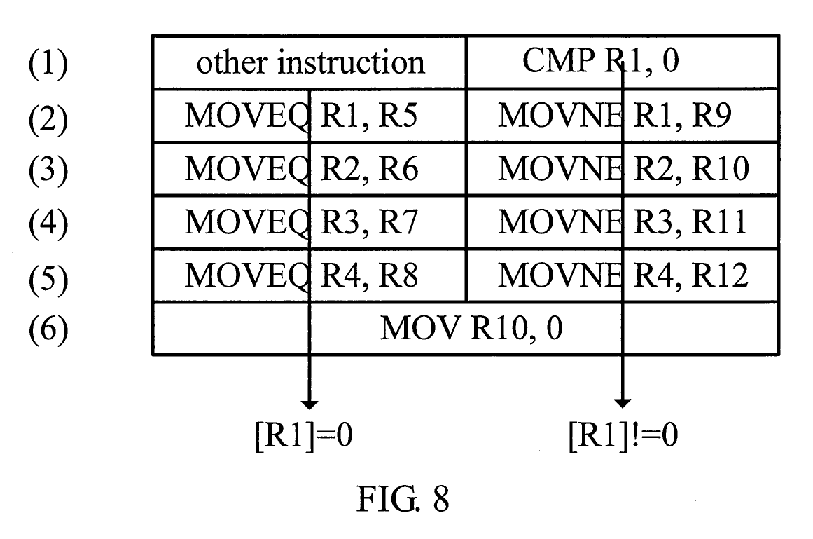

FIG. 8 is a schematic view of another embodiment in accordance with the invention, which shows that the condition execution instruction is an N-bit (N=16) instruction. As shown, when the processor executes a condition execution instruction (CMP R1, 0) in the instruction (1), the flag 310 is set based on the result performed on the instruction. Because the other instruction in the instruction (1) does not affect the flag, the processor is still based on the flag 310 to select first N-bit instruction (MOVEQ R1, R5) or second N-bit instruction (MOVNE R1, R9) of the parallel condition execution instructions (2) to (5) to execute.

In view of the foregoing, it is known that the invention does not require the prior 4-bit condition field so as not to waste the instruction encoding space, and can use shorter instruction codes to encode subsequent instructions to be performed after the condition instruction, thereby increasing the code density. When the invention performs a program as shown in FIG. 1, it takes only 6 clocks, which are much less than 10 clocks required by the prior art. At this point, no instruction cycle is wasted on instructions for discarding execution results. Therefore, the performance in the invention is much better than that in the prior art.

Although the present invention has been explained in relation to its preferred embodiment, it is to be understood that many other possible modifications and variations can be made without departing from the spirit and scope of the invention as hereinafter claimed.

What is claimed is:

1. A processor capable of executing conditional instructions, which executes an instruction set including M-bit instructions and N-bit instructions (where M, N are positive integers, M>N), the instruction set having condition execution instructions and M-bit parallel condition execution instructions, the parallel condition execution instruction having a first N-bit instruction and a second N-bit instruction, the processor comprising:
a flag having a state;
an instruction fetching device, to fetch at least one instruction to be performed;
an instruction decoder, to decode the instruction fetched by the instruction fetching device;
an instruction executing device, to execute the instruction outputted by the instruction decoder, wherein the state of the flag is set according to a result of executing a condition execution instruction, which indicates a state of condition acceptance or rejection; and
a mode switching device, to switch the instruction decoder to decode one of the first and the second N-bit instructions according to the state of the flag, so as to be subsequently performed by the instruction executing device, when a parallel condition execution instruction is fetched by the instruction fetching device.

2. The processor as claimed in claim 1, wherein, when the instruction executing device executes a condition execution instruction, the flag is set to a first logic state if the execution results in a condition acceptance, and set to a second logic state if the execution results in a condition rejection.

3. The processor as claimed in claim 2, wherein the first logic state is “true” and the second logic state is “false”.

4. The processor as claimed in claim 2, wherein the first logic state is “false” and the second logic state is “true”.

5. The processor as claimed in claim 2, wherein, when the instruction is a parallel condition execution instruction and the flag is on the first logic, the mode switching device switches the instruction decoder to decode the first N-bit instruction, so as to be subsequently performed by the instruction executing device.

6. The processor as claimed in claim 2, wherein, when the instruction is a parallel condition execution instruction and the flag is on the second logic, the mode switching device switches the instruction decoder to decode the second N-bit instruction, so as to be subsequently performed by the instruction executing device.

7. The processor as claimed in claim 2, wherein the condition execution instruction is an M-bit instruction.

8. The processor as claimed in claim 2, wherein the condition execution instruction is an N-bit instruction.

9. The processor as claimed in claim 1, wherein M is 32 and N is 16.

10. A method capable of executing conditional instructions in a processor, the processor executing an instruction set with M-bit instructions and N-bit instructions (where M, N are positive integers, M>N), the instruction set having condition execution instructions and M-bit parallel condition execution instructions, the parallel condition execution instruction having a first and a second N-bit instructions, the method comprising:
(A) fetching at least one instruction to be decoded and executed;
(B) when a condition execution instruction is performed, setting a flag to a first logic state if the execution results in a condition acceptance, and setting the flag to a second logic state if the execution results in a condition rejection; and
(C) when the instruction fetched is a parallel condition execution instruction, decoding and executing the first N-bit instruction if the flag is on the first logic state, and decoding and executing the second N-bit instruction if the flag is on the second logic state.

11. The method as claimed in claim 10, wherein the first logic state is “true” and the second logic state is “false”.

12. The method as claimed in claim 10, wherein the first logic state is “false” and the second logic state is “true”.

13. The method as claimed in claim 10, wherein the condition execution instruction is an M-bit instruction.

14. The method as claimed in claim 10, wherein the condition execution instruction is an N-bit instruction.

15. The method as claimed in claim 10, wherein M is 32 and N is 16.
